(19) United States
(12) Patent Application Publication
(10) Pub. No.: US 2007/0182350 A1
(43) Pub. Date: Aug. 9, 2007

(54) Method and apparatus for controlling an electric motor

(75) Inventors: Dean James Patterson, Lincoln, NE (US); Steven Peter Camilleri, Darwin (AU); Lyell Douglas Embery, Darwin (AU); Byron John Kennedy, Darwin (AU); Rafal Paul Rohoza, Darwin (AU)

Correspondence Address: BROOKS KUSHMAN P.C., 1000 TOWN CENTER, TWENTY-SECOND FLOOR, SOUTHFIELD, MI, 48075, US

(73) Assignee: IN MOTION TECHNOLOGIES, Darwin, N.T. (AU)

(21) Appl. No.: 10/598,579

(22) PCT Filed: Mar. 4, 2005
(86) PCT No.: PCT/AU05/00301

§ 371 Date: Sep. 5, 2006

(30) Foreign Application Priority Data
Mar. 5, 2004 (AU) 2004901274

(51) Int. Cl. H02P 7/00

(52) U.S. Cl. 318/432

(57) ABSTRACT

The present invention provides a method for controlling the output power of a permanent magnet electric motor (102) using a control means (106). The control means (106) includes a means (134) for measuring motor speed (134) and motor phase current (134), and a means for controlling motor phase current (110) to a desired level. A known relationship between motor phase current and motor torque is then employed by a torque controller so that motor shaft torque can be controlled. A power limiting means (128) then limits the output mechanical power of the motor by dividing a limit value of power by the motor speed to produce a maximum allowable torque setting for that speed.

### FIELD OF THE INVENTION

The present invention relates to a method of and apparatus for controlling a permanent magnet type electric motor. In a typical application, the method and apparatus may be used to control a permanent magnet type electric motor for a battery powered electric vehicle such as a bike, car, boat or the like.

### BACKGROUND TO THE INVENTION

Electric motors are used in a variety of different applications. One such application includes providing an electric traction system for electric vehicles.

Generally speaking, in electric vehicles which employ electric traction, electrical power is supplied to an electric motor from a suitable electrical power source (such as a battery) through a motor drive circuit. Typically, the electrical power supplied to the electric motor is regulated (for example, by increasing or decreasing an effective voltage which is supplied to the electric motor) by a control system associated with the motor drive circuit so as to adjust the output power of the electric motor.

The majority of electric motors currently applied to electric vehicle traction applications are brushed DC type motors. Motors of this type may be controlled using a relatively simple control system.

One such control system employs a binary control scheme (such as a simple “on-off”switch). Control systems of this type are able to be activated by an operator (normally the driver of the vehicle) so as to connect, or disconnect, electrical power to the electric motor. As will be appreciated, a control system such as this, which offers only “power or no power”, has limited controllability and thus limited usefulness. The limited controllability provided by a control system which employs a binary control scheme may give rise to conditions which could lead to damage of the electric motor. For example, a motor shaft stall condition (such as when the vehicle encounters a severe uphill grade) may cause excessive currents to flow within the electric motor and will likely lead to damage.

Typically, control systems which employ a simple “on-off” type motor control of the type described above, may employ an extremely small and lossy electric motor having an inherent protection capability (usually the electric motor's high parasitic resistance) which tends to limit otherwise damaging currents. However, such electric motors have an extremely limited power output and efficiency under normal conditions. Accordingly, these electric motors have limited application. Indeed, heating generated by the parasitic resistances during operation of the electric motor may render the electric motor unsuitable for large motor drive applications.

Simple “on-off” type switched control systems allow an operator to have either zero output power from the electric motor (such as will be provided in the “off” switch position), or some indeterminate amount of power (such as will be provided in the “on”switch position), the actual output power being determined by arbitrary conditions such as power supply voltage, motor load and motor speed. Thus, in such a simplified control system it is not possible to control the absolute level of output power, usually leading to wide variations in the output speed of the electric motor according to the load.

In another example of a control circuit, the on-off switch is replaced with a resistive potentiometer (or bank of switchable series resistors) that is controllable by an operator so as to add an adjustable resistance in series with the electric motor. Here, a voltage drop across the adjustable resistance will thus change the current flow through windings of the electric motor, providing some controllability by effectively allowing a range of different voltages to be applied to the motor. Although such a control system has improved controllability over the simple on-off switch type control, power losses in the potentiometer (or resistors) renders this type of control system somewhat inefficient. Moreover, whilst the addition of the controllable resistance between an electric motor and the power supply allows control of the output power of the motor, the level of output power control is not inherently linked to the resistance but is dependent on other factors such as power supply voltage, motor speed and load. Accordingly, the output power provided by a particular setting will tend to vary according to variations in the other factors.

Modern control circuits for electric motors typically employ power electronic switching devices (such as transistors) which allow for adjustment of the flow of electrical power from the electrical power source to the electric motor, rather than using a controllable resistance. One example of a control circuit which employs electronic switching devices for use with a direct current (DC) power source is a “chopper” control circuit.

Chopper type control systems rapidly connect and disconnect the electric motor from the electrical power source at a fixed frequency with an adjustable ratio (that is, the duty cycle) between the “connected” time and “disconnected” time so as to vary the voltage which is applied to the terminals of the electric motor.

The duty cycle of a chopper controller typically corresponds to the position of an accelerator which is operated by an operator of a vehicle having the electric motor. Thus, here the motor drive circuit increases or decreases the voltage to be supplied to the electric motor according to the duty ratio so as to make the output operation of the electric motor correspond to the accelerator position. As will be appreciated, “chopper”type control systems simply apply the voltage of the power source to the electric motor terminals for a proportion of a time period, and connect the terminals of the electric motor together for the remainder of the time period.

Whilst direct adjustment of the duty cycle, such as provided by a “chopper” controller, may again allow an intuitive level of relative increase or decrease in the output power of the electric motor, absolute control is much more difficult to achieve due to the effects of other variables such as motor speed or the voltage supplied by the power source. Indeed, “chopper” type control provides an imperfect motor speed control, since application of a fixed voltage to the terminals of a permanent magnet or shunt-wound DC motor will cause the electric motor to spin to a speed that is in proportion to the voltage applied for a no load condition. As load is applied to the electric motor the relationship between speed and voltage changes in a complex fashion depending on the various characteristics of the electric motor. The change in this relationship changes the motor speed produced for a particular control setting.

By way of example, FIG. 1 shows a set of power/speed curves that could be obtained from an electric motor/chopper combination at different duty cycle settings (shown here as Settings 1 to 5). Here, “Setting 1” provides a minimum duty cycle to the electric motor, thereby providing a power/speed curve which peaks at only 50 watts, corresponding to a minimum setting. On the other hand, “setting 5” corresponds to a maximum setting, which provides an output power peak of approximately 150 watts.

As is shown in FIG. 1, at each setting the electric motor will produce an output power that varies with speed and thus for a particular setting the electric motor does not provide a single output power value throughout the speed range. Instead, the power/speed curves are “scaled” as the duty ratio is adjusted, providing the intuitive increase or decrease in output as described earlier rather than control of output power.

Whilst “chopper” type control provides a controllable level of voltage to the electric motor from a fixed voltage source, variations in loading on the electric motor will vary the output power of the traction motor powering the vehicle independently of the accelerator position. Thus, chopper type control systems do not allow an operator to control the values of motor speed, torque or absolute output power of the electric motor. Instead, control systems of this type allow for intuitively increasing or decreasing these values in a relative manner depending on loading.

Moreover, “chopper” type control may allow dangerously high levels of current in power electronic switching devices during high load conditions that tend to reduce the speed of the electric motor (for example, such as when climbing a hill). One attempt to overcome this problem involves including a single current sensor in a current path between the power supply and the electric motor and shutting down the controller in response to detecting an over-current condition (that is a current level which exceeds a threshold value). However, this technique provides a somewhat unpredictable electric motor performance in that different conditions will cause the electric motor to shut down.

It is the aim of the present invention to provide a relatively simple method of, and apparatus for, controlling the output power of a permanent magnet electric motor for application in an electric traction system for a vehicle.

The discussion of the background of the invention as provided herein is included to explain the context of the invention. This is not to be taken as an admission that any of the material referred to was published, known or part of the common general knowledge in Australia or in any other country as at the earliest priority date of the invention.

### SUMMARY OF THE INVENTION

In a first aspect the present invention provides a method of controlling the output power of a permanent magnet electric motor, the method including:

(a.) setting a limit value of motor output power, said limit value of output power being indicative of an output power limit for the electric motor;

(b.) detecting a value of speed for the electric motor;

(c.) processing said obtained speed value and said limit value of output power so as to provide a target torque value; and

(d.) processing said value of target torque value so as to provide a control signal for adjusting an electric current supplied to the electric motor so as to thereby vary the output torque of the electric motor toward the target torque value.

In another aspect the present invention provides a control system for controlling the output power of a permanent magnet electric motor, the control system including:

(a.) a limiter means for:
i. setting a limit value of output power;
ii. detecting a speed value of the electric motor; and
iii. processing said detected value of speed and said limit value of output power so as to provide a target torque value; and

(b.) a control means for processing said target torque value so as to provide a control signal for adjusting an electric current supplied to the electric motor to thereby vary the output torque of the electric motor toward the target torque value.

In a third aspect present invention provides a programmed computer for controlling the output power of a permanent magnet electric motor for an electric traction system for a vehicle, the programmed computer including:

(a.) a processing means;

(b.) a memory for storing executable instructions, said executable instructions being executable by the processing means to make the processing means:
i. set a limit value of output power for the motor;
ii. detect a speed value of the electric motor;
iii. process said detected speed value and said limit value of output power so as to provide a target torque value; and
iv. process said target torque value so as to provide a control signal for adjusting an electric current supplied to the electric motor so as to vary the output torque of the electric motor toward the target torque value.

Throughout this specification, reference to the expression “output power of the electric motor” is to be understood to refer to the mechanical output power of the electric motor.

An advantage of the present invention is that the output power of the electric motor may be controlled so as to maintain a substantially constant output power value throughout a continuum of speed values.

The electric motor may be any suitable type of permanent magnet motor. In a preferred form of the invention the electric motor is a brushless electric motor having three phase windings.

In a preferred form of the invention the limit value of output power is set at a value indicative of an output power limit. Preferably, the output power limit is that of the electric motor.

In a further preferred form of the invention the limit value of output power is a value determined by using a processing function which maps the detected speed value to the predetermined target torque value.

In a still further preferred form the mapping of the detected speed value to the target torque value is derived using a relationship that defines a mapping between a continuum of speed values and the limit value of output power.

In yet a further preferred form the target torque value is calculated by using the equation:

$$τ = \frac{P}{ω}$$

where:

τ=target value of output torque required in Newton-Metres (Nm);

P=limit value of motor output power in watts (W); and

ω=detected speed value (in radians per second).

In an embodiment, the method is performed by a control system. In one embodiment, the control system and the electric motor may form a part of a electric traction system which itself may be used to drive an electric vehicle such as a battery powered bike, scooter, car, boat or the like. In another embodiment the control system and the electric motor may form part of an electric drive system for an electric powered machine, an electric power tool (such as an electric drill), an electric powered winch or the like.

It is preferred that the electric traction, or drive, system also includes a power controller for controlling the current which is supplied to the electric motor under the control of the control system. In one embodiment, the electric traction system, or drive, system is coupled to an electrical power source for providing electrical power to the electric motor. In an embodiment of the invention the electrical power source is a battery. For the purposes of this description, the combination of the control system and the power controller will be referred to as the “motor drive system”.

Although the present invention may be used on a range of different types of applications, it is envisaged that the present invention will be particularly suitable for electric traction systems for smaller electric vehicles such as golf carts, materials handling equipment vehicles (such as a forklifts) or electric utility trucks as well as hybrid electric vehicles such as electric bicycles, electric wheelchairs, mechanical scooters and kick scooters.

A particular advantage of the present invention is that it provides for direct control of the output power of the electric motor. Such direct control leads to other advantages, which will be described in more detail later.

In an embodiment, the limit value of output power is a value that has been obtained using a processing function which maps the obtained value of speed to a particular target torque value. In one form of this embodiment, the mapping of the obtained value of speed to a target torque value may be derived using a relationship that defines a mapping between a continuum of speed values and a respective limit value of output power. In one embodiment, the relationship may result in the target torque value having a value that is less than a target torque value calculated using the equation.

In another embodiment, the limit value of output power may be a value of output power which is indicative of an output power limit (for example, an output power limit of the electric motor). Thus, in this case the limit value of output power may have a predetermined maximum value which is indicative of the output power limit.

In an embodiment which uses batteries as the electrical power source, foreknowledge of the efficiency of the electric motor and the efficiency of the control system allows for the determination of a predicted battery drain. Thus, in one embodiment of the invention, the obtaining of a limit value of output power includes processing values which are indicative of losses of the electric motor and the motor drive system so as to obtain the limit value of output power.

A control system which processes values which are indicative of the electric motor losses and the motor drive system losses so as to obtain the limit value of output power of this type is particularly beneficial since it allows for the determination of battery drain without requiring additional sensors. In this respect, it is envisaged that this embodiment will also be well suited to a fuel-cell type power supply, where output power is typically limited to a constant value.

An additional advantage of this form of the invention is that it allows for the management of the electrical power which is drawn from the electrical power source (that is, the input power). Indeed, in an embodiment where the electrical power source includes one or more batteries, the limit value of output power may have a predetermined relationship with the available input power. Thus, in one embodiment the limit value of output power is a value which has been calculated according to the output power capacity of the one or more batteries. In this embodiment, battery power limits may be used so as to limit the drain on the battery.

Advantageously, in embodiments where the electrical power source includes a battery, managing the input power by way of managing the electrical power which is drawn from the battery provides additional benefits including, minimising the possibility of over-discharging the battery, the ability to reduce the rate of discharge of a battery at low levels of charge so as to allow a safe complete discharge, the ability to safely control the amount of regeneration into a battery and the ability to comply with statutory requirements for output power of the electric motor regardless of motor speed.

Thus, embodiments of the present invention may also control the input power which is provided to the electric motor and the motor drive system. In one embodiment, this is accomplished by combining the ability to control output power of the electric motor with foreknowledge of the efficiency of the electric motor and the efficiency of the motor drive system. It is preferred that foreknowledge of the electric motor efficiency and the motor drive system efficiency is obtained by measuring efficiency values for the electric motor and for the motor drive system.

In one embodiment, the efficiency values are stored into a digital memory on, or accessible to, the control system. Preferably, these values are used to derive an approximate value of input power for a respective output power value.

In another embodiment, multiple efficiency values (each efficiency value being for a respective output power) may be stored so that an entire range of output power and speeds can be used. Advantageously, this allows input power to be determined with improved accuracy by interpolation. Alternatively, an efficiency versus speed plot can be approximated by a linear equation which is recorded and referenced instead.

Preferably, where a relationship between input power and output power is approximately known, input power (that is, input electrical power) may be approximately controlled by controlling the output power of the electric motor.

Advantageously, the ability to control input power is useful for a wide range of applications. For instance, battery powered electric vehicles can incorporate a “safe maximum” battery discharge level, which can be dependent on battery state of charge. This can extend the discharge time as well as battery lifetime. The same approach may be extended to fuel cell powered vehicles which need to ensure the fuel cell is not overloaded, and can optimise the use of the fuel cell by continuously draining it at the optimum rate despite changes in vehicle speed. Additionally, mains operated electric motor devices such as power tools can operate at the maximum safe limit of a single phase power supply throughout their entire speed range, rather than having to rely on providing only a peak output power at the maximum safe limit, which can reduce the need to rely on more expensive three phase power supplies.

It is preferred that the detected speed value is a rotational speed value of the electric motor's output shaft. In one embodiment, the detected speed value may be derived by processing a signal which is indicative of the electric motor's output shaft (or rotor) position. However, it will be appreciated that the invention need not be so limited. Indeed, in other forms of the invention the detected speed value may be a rotational or linear speed of an object which is mechanically coupled (either directly or indirectly) to the electric motor's output shaft. By way of example, such objects may include a gear or a wheel.

The processing of the detected speed value and the limit value of output power to provide a target torque value may be achieved using any suitable processing arrangement. Preferably, the target torque value is that value of output torque which produces an output power which is substantially the same as, or within a range about, the limit value of output power. In a preferred embodiment, the target torque value is be calculated using the following equation:

$$τ = \frac{P}{ω}$$

where:

τ=target value of output torque required in Newton-Metres (Nm);

P=limit value of motor output power in watts (W); and

ω=obtained value of speed (in radians per second).

It will be appreciated by those familiar with the art that the above equation requires an infinite value of output torque at a zero speed value, and very high values of torque at speed values slightly above zero. However, high values of output torque will require high values of phase current. Such high currents may lead to damage to the electric motor or, indeed, the motor drive system. Moreover, an infinite value of output torque is physically impossible. In an embodiment, a torque limit value is placed on the target torque value at low speeds. Preferably, the torque limit value defines a “maximum continuous torque” value that the control system can safely produce.

In an embodiment, the torque limit value extends over a continuum of speed values until the value of “maximum continuous torque” and the target torque value (as described by the above equation) are substantially equal, whereupon normal control of the torque and power resumes. In this respect, “normal control” will be understood to be reference to output power control of the type that is governed by above equation.

For the purposes of this description, the detected speed value at which the torque limit value and the target torque value (that is the torque described by the above equation) are substantially equal will be referred to as the minimum speed at which output power control can be safely implemented.

It is preferred that the step of providing a control signal includes providing a control signal having a duty cycle which adjusts a switching pattern of a power controller that supplies an electric current to the electric motor. In one embodiment, the step of providing of the control signal includes processing a reference current value, having a value that has been derived from the target torque value and thereafter processing the reference current value, so as to provide the control signal. Thus, in one embodiment, the reference current value is processed by a current controller to thereby provide the control signal.

In one embodiment, the duty cycle of the control signal controls a switching pattern of the power controller so as to control the phase currents of the electric motor so as to thereby control the output torque generated by the electric motor to thereby correct the output torque of the electric motor correct the output torque of the electric motor so according to the target torque value.

In one form of the invention, the magnitude of the phase currents may be controlled so as to have a sinusoidal characteristic when the shaft of the electric motor is rotating. Preferably, in this embodiment, the sinusoidal phase currents will have a frequency which corresponds to the rotational speed of the output shaft so as to thereby form a uniform flux wave which rotates synchronously with the electric motor's rotor. For the purpose of this description this type of control will herein be referred to as “sinusoidal current control”.

In an embodiment, adjustment of the output torque of the electric motor according to the target torque includes varying the output torque so as to be substantially identical to the target torque value. In another embodiment, adjustment of the output torque of the electric motor according to the target torque value includes varying the output torque so that the output torque falls within a torque band which includes the target torque value.

### BRIEF DESCRIPTION OF THE DRAWINGS

The invention will now be described in further detail by way of example with reference to the attached drawings illustrating embodiments of the invention. It is to be appreciated that the particularity of the drawings does not supersede the generality of the description. In the drawings:

FIG. 1 is a graph of plots showing a series of power/speed curves for an electric motor controlled by a prior art control system;

FIG. 2 is a high level block diagram of a control system according to an embodiment of the invention;

FIG. 3 is a plot showing torque and power vs. speed, showing the effect on output power of torque capping at low speed;

FIG. 4 is a graph showing an efficiency plot of a typical electric motor and motor drive system;

FIG. 5 is a graph showing a plot of input and output power vs. speed for an electric motor and motor drive system combination, in which the input power has been estimated from the plot shown at FIG. 4;

FIG. 6 is a high level block diagram of an output power controller according to another embodiment of the invention; and

FIG. 7 is a flow diagram showing the steps of a method for controlling the output power of an electric motor according to a preferred form of the invention.

### DETAILED DESCRIPTION OF PREFERRED EMBODIMENTS OF THE INVENTION

The preferred embodiments of the invention will be described in terms of an electric traction system for an electric vehicle. However, it is to be appreciated that the present invention is not to be so limited. Indeed, it is envisaged that the method and apparatus of the present invention will also be applicable to other devices that include a permanent magnet electric motor electric motor, such as electric powered machines, electric power tools, electric powered winches and the like.

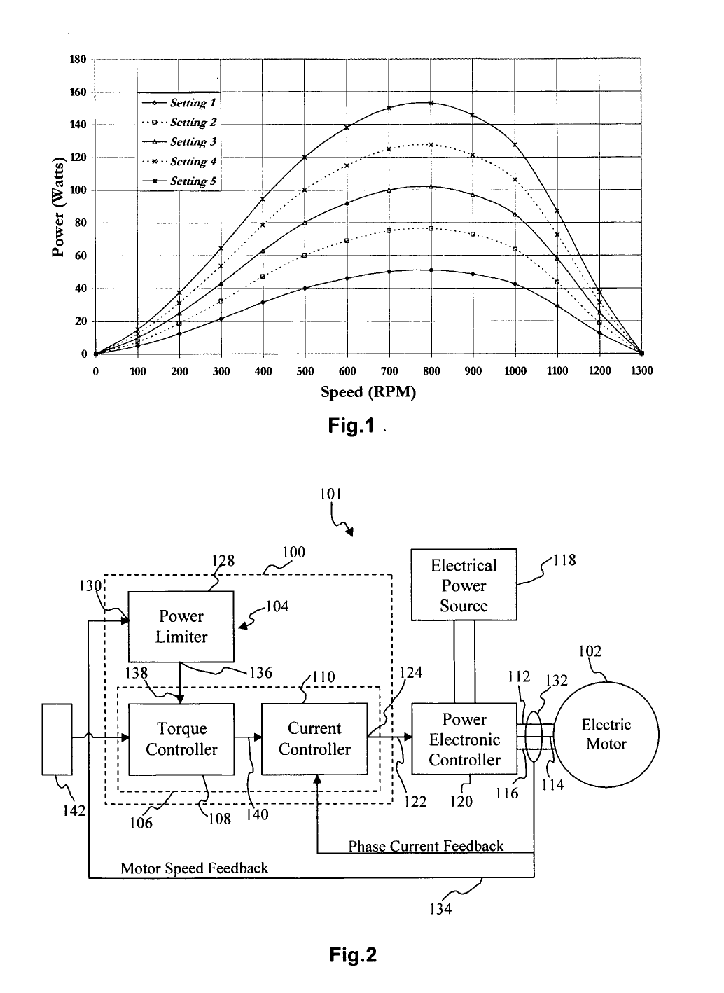

In FIG. 2, a control system 100 in accordance with an embodiment of the invention for controlling a permanent magnet type electric motor 102 (hereafter referred to as the “electric motor”) of an electric traction system 101 for a vehicle.

As is shown, the control system 100 includes a limiter means 104 and a control means 106. The control means 106 is shown here as a torque control means 108 and a current control means 110.

The control system 100 may be synthesised as an analog electronics module, a mixed signal module, or as a digital electronics module (for example, a digital signal processor such as a TMS320 2000 series programmed with executable instructions).

The electric motor 102 shown here is a three phase, brushless DC electric motor, with a conventional stator winding construction in which each of the three phases 112, 114, 116 are connected, via a power controller (shown here as power electronic controller 120), to an electrical power source 118 (being a battery in this embodiment). The electric motor 102 also includes a rotor (itself including high strength magnets such as Neodymium Iron Boron or Samarium Cobalt magnets) mounted on a shaft. In the illustrated embodiment, the electric motor is a 12V brushless DC motor having a motor speed range of 0 to 400 RPM.

A power electronic controller 120 shown here is a conventional controller including a plurality of electronic switching devices, such as Metal Oxide Semiconductor Field Effect Transistors (MOSFETs) or Insulated Gate Bipolar Transistors (IGBTs). The electronic switching devices are arranged so as to control the electric current to flow from the electrical power source 118 through the motor phases 112, 114, 116 under the control of a respective control signal 122 from an output 124 of the control system 100.

In the illustrated embodiment, the power electronic controller 120 includes six electronic switching devices arranged in a three phase full bridge configuration. Also incorporated into the power electronic controller 120 are the appropriate support electronics to allow the electronic switching devices to switch, in a standard fashion, such as MOSFET or IGBT gate drivers, low voltage switch mode power supplies under the control of a respective control signal 122.

The power electronic controller 120 includes plural inputs which are interfaced with the output 122 of the control system 100 so as to allow the control system 100 to control (using a suitable control signal) switching of the electronic switching devices of the power electronic controller 120 so as to adjust the electric current supplied to the electric motor 102 to thereby correct the output torque of the electric motor 102 so as to be substantially identical to a target torque value. In this respect, any suitable type of control signal may be used to control the switching of the electronic switching devices. However, in the present case, conventional PWM (pulse width modulation) signalling is used.

The above-described electric motor 102 and power electronic controller 120 are exemplary, as the control system 100 may be used with other types of permanent magnet electric motors and other type of power electronic controllers and different combinations thereof. For the purpose of this description the combination of a control system (such as control system 100) and a power electronic controller (such as power electronic controller 120) will be referred to as the “motor drive system”.

Returning now to the description of the control system 100, in the embodiment illustrated, the limiter 104 is shown as a power limiter 128. The power limiter 128 shown includes an input 130 for receiving a signal from a sensor(s) 133 via feedback path 134, and an output 136 for providing a target torque value as an input 138 to the torque controller 108.

In the illustrated embodiment, the sensor(s) 132 provides a motor speed feedback signal to the power limiter 128 via the feedback path 134 so that the power limiter 128 can obtain a value of speed of the electric motor 102. In the present case, a motor speed feedback signal is provided for each phase 112, 114, 116 of the electric motor 102.

In the illustrated embodiment the, or each, sensor 132 is a current sensor that senses the phase current (in the form of sensed phase current values) in a respective phase 112, 114, 116. However, it is to be appreciated that the invention is not to be so limited. Indeed, in other embodiments a value of speed of the electric motor 102 may be obtained using a rotor position sensors (such as hall effect or shaft position encoder sensors). Moreover, although the illustrated embodiment includes a sensor 132 for each phase 112, 114, 116, in other embodiments, a sensor 132 may only be included in two of the three motor phases 112, 114, 116 and the phase current in the third phase (that is the motor phase not having a sensor) may be determined mathematically (for example, using Kirchoff's current law).

In the present case, a value of speed for the electric motor is obtained by the power limiter 128 processing the sensed phase current values so as to derive a fundamental frequency of the motor speed feedback signals and then processing the frequency value to obtain a value of speed for the electric motor 102. In this respect, in the embodiment illustrated the value of speed of the electric motor 102 is a value which is indicative of the rotational speed of an output shaft of the electric motor 102.

Having detected a speed value of the electric motor, the power limiter 128 then processes this obtained value of speed and the limit value of output power so as to provide a target torque value.

In the present case, the processing of the detected speed value and the limit value of output power is achieved by dividing the limit value of output power by the detected speed value, so as to provide the target torque value. In this respect, in the illustrated embodiment the limiter 104 provides a new target torque value to the torque controller 108 at a rate of 48 times per revolution of the rotor of the electric motor 102 as determined from an obtained value of speed sensor (and so varies with the speed of the electric motor)

In the illustrated embodiment, the target torque value is “capped” at a maximum level which corresponds to the capability of the electric motor 102 and the control system 100. Advantageously, torque capping provides for control of the output power of the electric motor 102 in a manner which reduces the likelihood of high phase currents which would otherwise be caused during operation of the electric motor 102 at low speeds.

In the present case, torque capping is implemented by defining a torque limit value for the target torque value during low speed operation. Thus, the torque limit value defines a “maximum continuous torque” value that the control system 100 can safely produce.

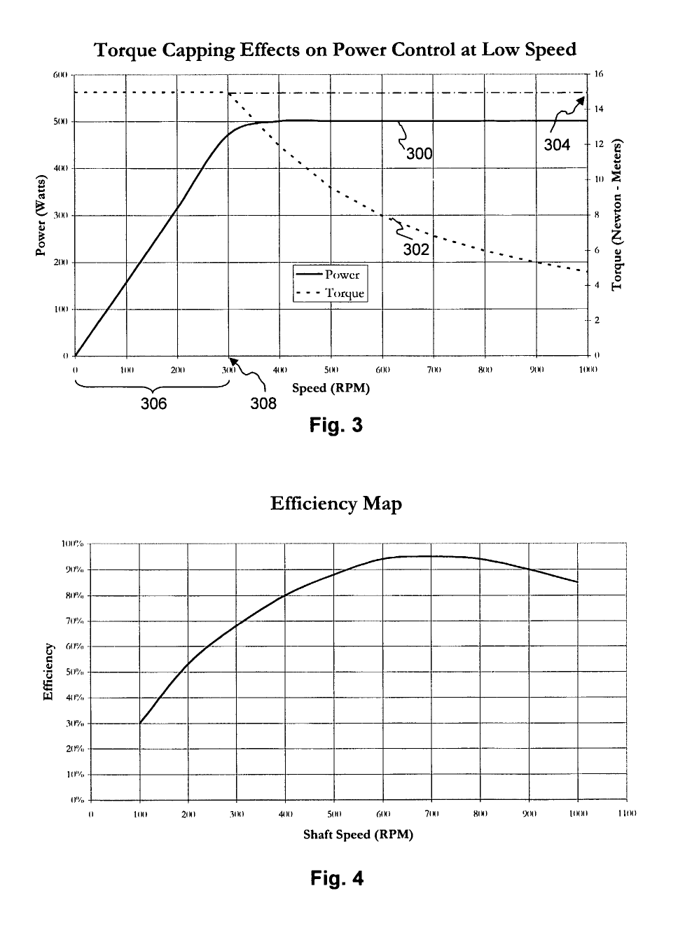

An example of the effect of torque capping is illustrated in FIG. 3. Here, the effect of torque capping is to provide an electric motor power output characteristic 300, in which the value of output torque 302 has been capped to a torque limit value 304 (hereafter referred to as “maximum continuous torque”) of approximately 15 Nm at speed values less than approximately 300 RPM.

Thus, in the illustrated example, the maximum continuous torque value 304 extends over a continuum of speed values 306 until a value of speed occurs 308 at which “maximum continuous torque” and the target torque value are substantially equal. At higher speed values, normal control of the output power and output torque is effected.

As is shown in FIG. 3, the torque capping causes the output power characteristic 300 to ramp up from 0 RPM to 300 RPM in a linear fashion. Above approximately 300 RPM (that is, once normal control resumes) the output power of the electric motor 102 is maintained at the limit value of output power 304.

Returning now to FIG. 2, In the embodiment illustrated the torque controller 108 includes an input 138 for receiving the target torque value from the power limiter 128.

In the embodiment illustrated, the torque controller 108 processes the target torque value so as to provide a current control signal 140 at an output of the torque controller 108. In the present case, the current control signal 140 includes a signal which conveys a current reference value to the current controller 110. In the illustrated embodiment, the current reference value is proportional to the target torque value.

In response to receiving the current control signal 140 from the torque controller 108, the current controller 110 provides a control signal(s) 122 for adjusting the switching pattern of the power electronic controller 120. The control signal(s) 122 adjusts the electric current supplied to the electric motor 102 from the electric power source 118 so as to correct the output torque so as to be substantially identical to the target torque.

In the present case, the electric current supplied to the electric motor 102 is adjusted so as to be substantially identical to the reference current value received from the torque controller 108. As described previously, in the illustrated embodiment, an adjustment of this type corrects the output torque of the electric motor 102 so as to be substantially identical to the target torque value.

In the case of a permanent magnet electric motor, such as is described in relation to the present embodiment, the output torque of the electric motor 102 is proportional to the electric motor 102 phase current of the motor throughout a normal operating region. Thus, in the illustrated embodiment, the output torque of the electric motor 102 is controlled by the controlling the phase currents according to the reference current value provided by the torque controller.

Methods for controlling the phase current of an electric motor would be well understood by a skilled control system engineer. Such methods typically involve measuring a rotor position of the electric motor and at least two phase currents and applying an algorithm to generate a duty cycle signals so that the phase currents of the electric motor 102 are controlled to the level desired (in this case, the reference current value). By way of a non-limiting example, hysteresis band current control and vector control are two such methods. In the present embodiment, the current controller control measures current and generates the control signal at 14 kHz using vector control and space vector modulation.

Having described the control system 100, the description will now turn to the operation of the control system 100.

The illustrated control system 100 can operate in one of two modes. In a first mode, (hereafter referred to as the “throttle-less” mode) the limit value of output power (and the target torque “cap”) are pre-set and the electric motor 102 tracks these maxima throughout its operating range. The first mode is useful, for example, in the case of electric bicycles where the electric motor power is limited by law and is “never enough”, so to set to the maximum level compliant with relevant laws and provide an on/off control allows for easy drivability.

In a second mode, the control system 100 can be operated with both the power limiter 128 and a throttle 142. Here, the power limiter 128 effectively defines an “envelope” of output power within which the throttle 142 can adjust the output power of the electric motor 102. Advantageously, the second mode allows a level of output power control and also provides a restriction on the output power the electric motor 102 can generate over a continuum of speed values.

The inventive method may also be extended to control input power. However, to describe how this is effected, first an understanding of how the input power to the system may be estimated without being measured is described.

Here, a control system 100 is programmed in advance with information relating to the efficiency of the electric motor and the motor drive system at particular output power levels. FIG. 4 shows an exemplary efficiency/speed curve for an electric motor and motor drive system, with efficiency defined as “the ratio of output mechanical power in watts to input electrical power in watts”. The example assumes that output power is constant over the entire range of speed, indicating that as efficiency changes so will input power.

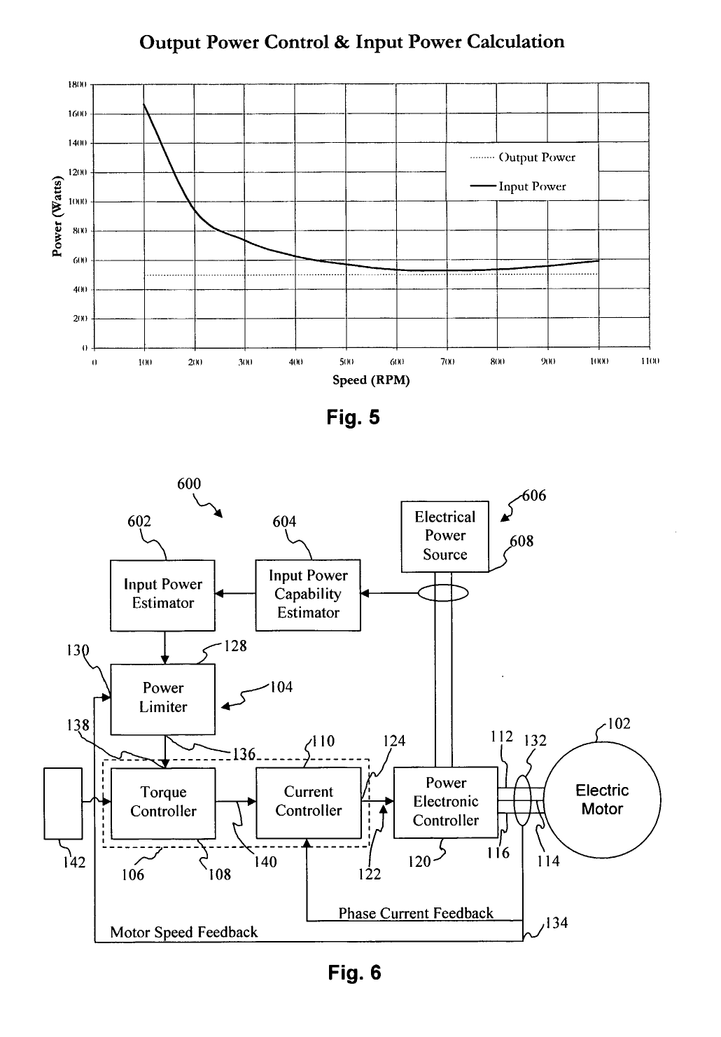

A corresponding example is shown in FIG. 5 which shows both input power and output power, in watts, versus speed as generated from the data shown in FIG. 4. Thus, it is possible to use this advance information, combined with the output power control method as previously described, to estimate the input electrical power to the electric motor 102 and the motor drive system.

It will be appreciated by those skilled in the art that the efficiency of the electric motor 102 will change according to output power, so the afore-described simplistic method to estimate input electrical power only holds when the output power is set to be the same as is recorded in the advance knowledge. Moreover, it is quite difficult to measure the efficiency of the motor drive system throughout an infinite spectrum of speeds and output powers, and thus derive a manner to estimate input power across the same infinite range. Accordingly, since in the present case, the input power is only an estimate, in some embodiments computational methods are used instead to simulate an infinite range.

In one embodiment, the computational method entails measuring efficiency/speed curves through a nominal range of output powers and interpolating efficiency information for a particular output power within the nominal range. Advantageously, this approach provides a result that is as precise as needed, given memory constraints.

In another embodiment, various efficiency/speed curves may be approximated by a polynomial equation which is entered into a memory (or indeed, an entire range of efficiency/speed/power curves mapped as a geometric surface with only the characteristic equation recorded). Irrespective of the method used to store the efficiency information for the electric motor 102 and the motor drive system in advance, the result will be that the control system 100 is able to estimate the input power of the electric motor 102 and the motor drive system for a particular output power and value of speed.

It should be noted that the approximation of efficiency will provide an approximate input power with corresponding precision. For instance, the efficiency of a motor drive system, all else being the same, will in general decrease with temperature. This has the effect of giving a high value of efficiency to the input power control system, which will then err on the side of drawing more input power than otherwise desired. In one embodiment, the control system 100 includes a temperature sensor for allowing temperature variations to be sensed and compensated for. In this respect, other sources for error in efficiency also exist, some or all of which can be improved by including suitable sensors, or increasing the complexity of an efficiency estimating algorithm. The efficiency estimating algorithm will be described in more detail below.

Given that the control system 100 as described is now able to control output power of the electric motor 102 and make a reasonable estimate for the input electrical power based on that figure, with minor modification the control system 100 may be configured to control input power. The main advantage of this configuration is to ensure that a restricted or limited power supply is both protected against overload and also operated very close to its maximum limit.

Thus, turning to FIG. 6 there is shown a control system 600 according to another embodiment of the invention. Control system 600 includes an input power estimator 602 and input power capability estimator 604.

The input power capability estimator 604 is typically implemented as a software routine or algorithm (“the efficiency estimating algorithm”) within a digital control device of the control system 600. The efficiency estimating algorithm measures characteristics of the restricted power supply 606 and creates an output in proportion to the level of power the power supply 606 can reasonably generate.

For example, should the restricted power supply 606 be a battery 608, a voltage measurement is taken. Since input power is known, based on the input power estimator 602 previously discussed, the amount of load on the battery 608 is also known. These two figures when combined give an approximate indication of the state of charge of the battery 608. Given that the input power capability estimator 604 has advance knowledge of the safe rate of discharge of the battery 608 based on state of charge information, the output power of the electric motor 102 can then be increased or reduced so that this safe rate of discharge is maintained. Thus, the battery 608 may be safely discharged at its maximum rate throughout the entire range of charge levels.

Additionally, when the battery 608 is discharged to a level where further discharge may cause damage, the output power of the electric motor 102 can be reduced to zero. As the battery 608 is recharged, the terminal voltage will recover and the algorithm will increase allowable output power of the electric motor 102 automatically.

Similarly if the restricted power supply 606 is a fuel cell, the optimum supply power is restricted by fuel feed rate. Thus, in one embodiment, the input power capability estimator 604 is supplied with information about the fuel feed rate and is programmed in advance to control the input power based on fuel feed so as to ensure that maximum power is always safely extracted from the fuel cell.

In another embodiment, the restricted power supply 606 includes a conventional mains power supply. Such supplies are typically restricted by law for safety reasons, for example to 240 V and 10A at a standard power receptacle. A power tool according to this embodiment of the invention might ensure that the input power is always within this range, maximising the output power the tool can generate and speeding progress, and at the same time safely and legally maximising the existing power delivery infrastructure. In the case of this example the input power capability estimator 604 is not required since the input power capability is always the same.

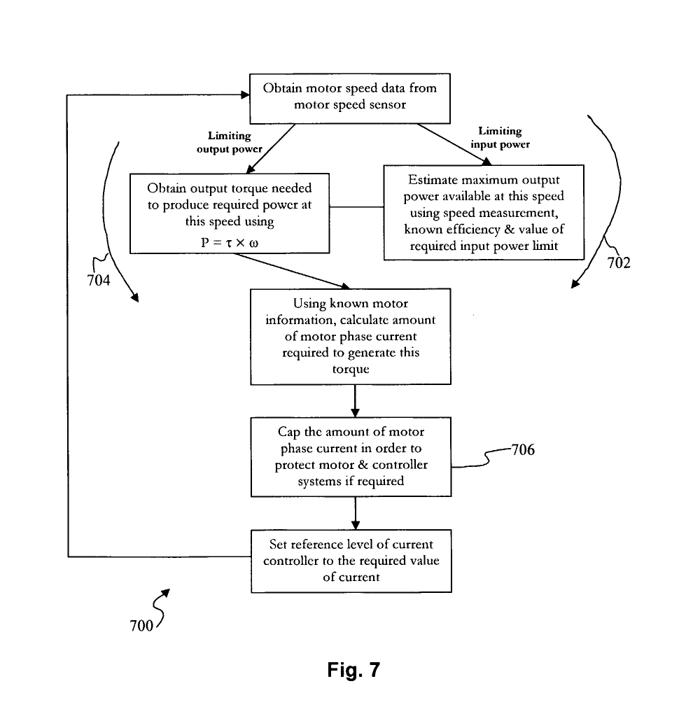

As will be appreciated, the control system 600 may be configured to provide output power control and/or input power control of the type described above. Indeed, FIG. 7 shows a flow diagram 700 of a method according to an embodiment which provides an input/output power control path 702 and an output power control path 704. As is shown, the illustrated method also includes a torque capping feature 706 of the type previously described.

It is to be understood that various additions, alterations and/or modifications may be made to the invention as previously described without departing from the ambit of the invention.

1. A method of controlling the output power of a permanent magnet electric motor, the method including:
(a.) setting a limit value of motor output power;
(b.) detecting a speed value of the electric motor;
(c.) processing said obtained speed value and said limit value of output power so as to provide a target torque value; and
(d.) processing said target torque value so as to provide a control signal for adjusting an electric current supplied to the electric motor to thereby very the output torque of the electric motor toward the target torque value.

2. A method as claimed in claim 1, wherein the limit value of output power is set at a value indicative of an output power limit.

3. A method as claimed in claim 2, wherein the output power limit is that of the electric motor.

4. A method as claimed in claim 3, wherein the limit value of output power is a value determined by using a processing function which maps the detected speed value to the predetermined target torque value.

5. A method as claimed in claim 4, wherein the mapping of the detected speed value to the target torque value is derived using a relationship that defines a mapping between a continuum of speed values and the limit value of the output power.

6. A method as claimed in claim 5, wherein the target torque value is calculated by using the equation:
$$T = \frac{P}{ω}$$
where:
T=target value of output torque required;
P=limit value of motor output power, and
ω=detected speed value.

7. A method as claimed in claim 6, wherein the limit value is determined with regard to losses in the electric motor and any drive system associated with the motor.

8. A method as claimed in claim 7, wherein the electric current is supplied by at least one battery and the limit value of output power is determined with regard to the output power capacity of the at least one battery.

9. A method as claimed in claim 8, wherein power supplied to the electric motor is controlled by controlling the output power of the motor in light of knowledge of the efficiency of the motor.

10. A method as claimed in claim 9, wherein the output torque is varied to be substantially identical to the target torque value.

11. A method as claimed in claim 9, wherein the output torque is varied to be within a predetermined range that includes the target torque value.

12. A method as claimed in claim 11, wherein the control signal has a duty cycle adapted to adjust a switching pattern of a power controller that supplies current to the electric motor.

13. A control system for controlling the output power of a permanent magnet electric motor, the control system including:
(b) a limiter means for:
i. setting a limit value of output power;
ii. detecting a speed value of the electric motor; and
iii. processing said detected value of speed and said limit value of output power so as to provide a target torque value signal; and
(b.) a control means for processing said target torque value signal so as to provide a control signal for adjusting an electric current supplied to the electric motor to thereby vary the output torque of the electric motor toward the target torque value.

14. A control system as claimed in claim 13, wherein the control system and the electric motor form a part of an electric drive or traction system.

15. A control system as claimed in claim 14, including a power controller for controlling the current supplied to the motor.

16. A system as claimed in claim 15, wherein the electric current is supplied by at least one battery.

17. A system as claimed in claim 16, wherein the control means includes a torque controller and a current controller, said torque controller receiving said target torque value signal and an optional throttle signal so as to provide an output current control signal to the current controller, said current controller also receiving a phase current feedback signal from the power supplied to the motor and outputs said control signal.

18. A system as claimed in claim 17, further including an input power capability estimator fed with a signal indicative of power being drawn from an electrical power source supplying the motor, said input capability power estimator supplying a signal to an input power estimator indicative of the power available to be drawn from the power source, and said input power estimator providing an output signal input to the limiter indicative of the power consumption of the motor.

19. A programmed computer for controlling the output power of a permanent magnet electric motor for an electric traction system for a vehicle, the programmed computer including:
(c.) a processing means;
(d.) a memory for storing executable instructions, said executable instructions being executable by the processing means to make the processing means:
i. set a limit value of output power for the motor;
ii. detect a speed value of the electric motor;
iii. process said detected speed value and said limit value of output power so as to provide a target torque value; and
iv. process said target torque value so as to provide a control signal for adjusting an electric current supplied to the electric motor so as to vary the output torque of the electric motor toward the target torque value.

20.-22. (canceled)
